(19) United States
(12) Patent Application Publication
(10) Pub. No.: US 2024/0183952 A1
(43) Pub. Date: Jun. 6, 2024

(54) MULTI-CHANNEL HIGH SAMPLING RATE REAL-TIME SYNCHRONOUS ACQUISITION AND STORAGE SYSTEM FOR BATHYMETRY LIDAR

(71) Applicant: GUILIN UNIVERSITY OF TECHNOLOGY, Guangxi (CN)

(72) Inventors: Guoqing ZHOU, Guangxi (CN); Haotian ZHANG, Guangxi (CN)

(73) Assignee: GUILIN UNIVERSITY OF TECHNOLOGY, Guangxi (CN)

(21) Appl. No.: 18/527,403

(22) Filed: Dec. 4, 2023

(30) Foreign Application Priority Data
Dec. 4, 2022 (CN) 202211545048.1

(51) Int. Cl. G01S 7/4861; G01S 7/00; G01S 7/484; G01S 17/89

(52) U.S. Cl. CPC G01S 7/4861; G01S 7/003; G01S 7/484; G01S 17/89

(57) ABSTRACT

The present disclosure relates to a lightweight and small bathymetry LiDAR multi-channel high sampling rate high-precision real-time synchronous acquisition and storage system, which adopts an ADC+FPGA+ZYNQ architecture to implement four-channel high-rate real-time synchronous parallel sampling, has synchronization error less than 300 ps, sampling rate s as high as 2 GSPS, and sampling precision as high as 14 bits, and comprises an FPGA system acquisition carrier board unit for implementing laser radar echo data acquisition and storage, PMT controlling, data maximum value feedback, peripheral interface design and storage control; a storage daughter board unit for implementing storage of echo data and export of 100 Mbps Ethernet, and an upper computer data conversion software for implementing conversion of original echo data files into decimal or hexadecimal csv files. The system has multi-channel parallel acquisition, high sampling rate and precision, strong real-time performance and functional applicability, and light weight and portability for bathymetry LiDAR.

### CROSS-REFERENCE TO RELATED APPLICATION

This application claims the priority benefit of China application serial no. 202211545048.1, filed on Dec. 4, 2022. The entirety of the above-mentioned patent application is hereby incorporated by reference herein and made a part of this specification.

### BACKGROUND

### Technical Field

The present invention relates to the field of LiDAR data acquisition with high sampling rate, and is particularly to a lightweight and small multi-channel real-time data acquisition and storage system with high sampling rate applicable to a bathymetry LiDAR.

### Description of Related Art

As a novel active remote sensing measurement device, LiDAR has widely been applied in topographic mapping, agricultural/forestry monitoring, atmospheric/marine monitoring, coastal water area measurement and other fields. A motor is added into a LiDAR system as a scanning device, and the LiDAR system is mounted on a moving platform such as an unmanned ship or an unmanned aircraft, so that water bottom terrestrial data of a target area is measured, and a water bottom three-dimensional terrain is modeled by combination with POS system data (comprising GPS data, posture data, and the like), scanning parameters (comprising a rotation speed, a rotation angle, a number of turns, and the like), and the like acquired. Therefore, data acquisition is a crucial link of a complete workflow of LiDAR.

However, when the LiDAR is equipped with a movement platform and a scanning device for data measurement. The speed of motor scanning and platform movement is high, a high sampling rate data acquisition system is required to have a high acquisition rate, a high acquisition precision and a strong real-time performance, so that there is a great difficulty in design, and there is no relevant content record about the bathymetry LiDAR and related data acquisition device. Meanwhile, there are the following technical requirements and problems when the water bathymetry LiDAR is applied for water depth measurement: firstly, when water bottom measurement is performed by the bathymetry LiDAR, the attenuation of water to laser is increased with increasing water depth, so that water bottom echo waves are acquired separately according to large and small apertures (which are namely “field” for a deep water channel and a shallow water channel). The difference between large field and small field is that an optical signal received by the large field has a wider range, with which an optical signal reflected from a deeper area can be received. Aiming at the above technical feature, the multi-channel real-time synchronous acquisition and storage system with high sampling rate according to the present invention must have the following features: firstly, the system can implement multi-channel parallel signal acquisition in real-time. Secondly, the measurement purpose of the bathymetry LiDAR is to generate a water bottom three-dimensional topographic map, thus, the importance of implementing this function is not only to acquire the water depth data, but also to store POS data and LiDAR motor parameters synchronously. Therefore, the multi-channel high sampling rate real-time synchronous acquisition and storage system must be able to store the above data in real time. Meanwhile, it is necessary to design a unique data processing format aiming at being stored for later data processing. To the end of the above technical features, the multi-channel high sampling rate real-time synchronous acquisition and storage system of the present invention needs to design a data format to store required data. In addition, all kinds of platforms such as an unmanned aerial vehicle or an unmanned ship for carrying on the bathymetry LiDAR run fast during cruising. Therefore, in order to ensure the integrity of acquired data, the multi-channel high sampling rate data real-time acquisition and storage system is required to have a high acquisition rate and strong real-time acquisition and storage capacities, and a low synchronization error between channels. Meanwhile, a large amount of data will be generated at a high sampling rate during the system working process. Therefore, it is necessary to select a storage disk with a large capacity, a fast storage speed and a large storage bandwidth. Subsequently, during the water depth measurement of the bathymetry LiDAR, in order to detect a deeper water bottom, laser energy needs to be increased. However, with the increase of the laser energy, the reflection of laser by a water surface becomes stronger, and an acquired waveform is saturated. To the end of the above technical feature, the multi-channel high sampling rate real-time synchronous acquisition and storage system of the present invention design and implement a gating signal capable of being delayed in output. The gating signal is applied to control a normally off type PMT to avoid the strong reflection of the water surface to acquire a water bottom signal clearly, preventing signal saturation. To meet an adjustment requirement of LiDAR when detecting at different flying heights, the delay time and signal pulse width of gating signal are adjustable. Finally, the parameters such as laser energy and PMT gain need to be adjusted in advance before the water depth measurement using bathymetry LiDAR. However, with the increase of the measured water depth, an echo signal becomes very weak, an original PMT gain is insufficient for a PMT to detect the echoes. It is impossible to adjust the PMT gain in real time during the measurement. To the end of the above technical feature, the multi-channel high sampling rate high sampling rate real-time synchronous acquisition and storage system of the invention designs a data maximum value feedback module, the maximum value data of the signals in one laser pulse is obtained and fed back to a main control system of the LiDAR. By comparing acquired data, the main control system can adjust the PMT gain in real time according to this value, so as to achieve the purpose of detecting a weaker echo from water bottom.

Aiming at an application requirement, a high-precision and high-sampling rate technology, a real-time data acquisition and storage technology, an FPGA design technology and a bathymetry LiDAR technology are combined herein, and a lightweight and small multi-channel high sampling rate high sampling rate real-time synchronous acquisition and storage system applicable to water depth measurement of a bathymetry LiDAR is proposed, designed and implemented. Aiming at working characteristics and acquisition difficulties of the bathymetry LiDAR, the system implements many functions, such as high sampling rate high sampling rate and high-precision real-time acquisition of water bottom echo data and real-time storage of high-bandwidth data, real-time transmission and real-time storage of POS system data, PMT gating signal control, real-time feedback of maximum value data of channel data, high-bandwidth data export and format conversion, and solves the problem of difficult signal acquisition caused by a fast scanning speed, strong reflection on the water surface and inability to manually adjust the PMT gain during the working process of the bathymetry LiDAR.

### SUMMARY

The present invention discloses a lightweight and small bathymetry LiDAR multi-channel high sampling rate high sampling real-time synchronous acquisition and storage system, to solve the problems of data acquisition and incomplete data acquisition caused by technical difficulties encountered during a working process of a bathymetry LiDAR through the data acquisition system, and provides a technical solution for the bathymetry LiDAR high sampling rate high sampling rate real-time synchronous acquisition and storage system at the same time.

The lightweight and small bathymetry LiDAR multi-channel high sampling rate real-time synchronous acquisition and storage system is composed of three parts an FPGA acquisition carrier board unit, a ZYNQ storage daughter board unit and upper computer conversion software.

Each of part is described in detail as follows: for the FPGA acquisition carrier board unit, an acquisition control chip is selected from a Kintex-7 series chip of Xilinx Company, named, XC7K480tffg901-2, and is configured for implementing time sequence control of the lightweight and small bathymetry LiDAR multi-channel high sampling rate real-time synchronous acquisition and storage system and design of the functions with various modules; and the acquisition carrier board unit is integrated with five SSMB-KW input interfaces for acquiring an external analog signal, wherein a trigger input interface is configured for acquiring a laser device trigger signal, a first acquisition channel is configured for acquiring a laser device main wave signal, a second acquisition channel is configured for acquiring a small field shallow water channel signal from a normally on type PMT, and a third acquisition channel is configured for acquiring a large field deep water channel signal from a normally off type PMT; four SSMB-KW output interfaces for outputting a gate signal, controlling an external device, and implementing light emission of a laser device and on-off control of the normally off type PMT in the present invention, wherein a first output channel is configured for controlling the light emission of the laser device, and a second channel to a fourth channel all output the gate signal for controlling the PMT; two high sampling rate ADC chips selected from AD9208 chips of ADI Company, wherein the chip has a sampling rate of 2 GSPS (up to 3 GSPS) and a sampling precision of 14 bits, the chip supports high sampling rate data serial output of a JESD204B protocol, meets a high sampling rate real-time acquisition requirement of the bathymetry LiDAR, and is configured for implementing data acquisition and analog-to-digital conversion of the external analog signal, and the driving of the module is implemented by FPGA design; one HMC7043 clock chip for providing a whole clock for the system, a high sampling rate ADC and a PLL, so as to implement data acquisition, which is namely system time allocation, and eliminate clock jitter at the same time, so that an error is reduced, a precision of output clock is greatly improved, and a guarantee is provided for high sampling rate real-time acquisition of a large amount of data of the bathymetry LiDAR; one 100 Mbps Ethernet interface configured for exporting data from a solid-state hard disk to a PC terminal in the present invention; one 1,000 Mbps Ethernet interface configured for triggering a transmission function of a POS system network interface in the present invention for POS data transmission; a UDP protocol designed by FPGA for continuously sending UDP data to a POS system while powering on the system; one J30J interface configured for system power supply and serial communication in the present invention; a self-designed communication protocol with contents comprising a working trigger mode of the laser device, data of a transmission code disk, peak data of AD of four channels and a parameter adjustment instruction of the gate signal; and one FMC interface configured for implementing internal data transmission, and storage instruction control and storage control of a storage board; to sum up, functions designed by the FPGA acquisition carrier board comprise high sampling rate A/D data acquisition, PMT gate signal output, POS network data transmission control, echo signal maximum value feedback, system data transmission, storage instruction control, serial instruction communication, and the like; for the ZYNQ storage daughter board unit, a daughter board chip is selected from a ZYNQ series chip of Xilinx, named ZYNQ Ultrascale+XCZU4CG, and is configured for receiving a storage instruction sent by the FPGA acquisition carrier board and implementing data storage, hard disks are selected from two Samsung 970EVO Plus NVMe M.2 solid states, a storage capacity of each solid state is 1 TB, and the solid state supports an NVME protocol, has a faster storage speed, is configured for implementing real-time storage of echo data, and has a storage bandwidth not lower than 3.5 GB/s; the storage board is integrated with two NVME M.2 solid-state slots and one FMC high sampling rate interface; and for the upper computer conversion software, the software is capable of converting an original binary file in the solid-state hard disk into a plurality of csv files in decimal format or hexadecimal format, a file conversion format is self-designed, and design contents comprise a number of triggering times, a time stamp, ADC1, ADC2, ADC3, ADC4 and POS data, so that matching of the POS data with corresponding echo waveform data during later data processing is guaranteed, thus ensuring correctness of point cloud data.

To sum up, the high sampling rate real-time synchronous acquisition and storage system designed in the present invention adopts the ADC+FPGA+ZYNQ architecture, the front end adopts two AD9208 chips of ADI Company and the HMC7043 clock chip, and echo signal data acquisition, A/D conversion and system multi-module clock management are implemented while reducing channel output delay; the FPGA carrier board implements the functions of acquisition control over the ADC chip, gate signal output, channel echo data maximum value feedback, system data transmission and storage protocol design, FMC high sampling rate interface design, and the like; and the ZYNQ storage board implements real-time storage of the echo data and an export function of Ethernet. The present invention has the advantages that: corresponding functional modules are designed according to a specific use environment of the bathymetry LiDAR and problems occurred; a multi-channel data high sampling rate and high-precision real-time acquisition requirement of the echo data of the LiDAR is met, and the echo data of four channels are completely stored in real time; the data are exported by the upper computer software, and the file format is converted; the functions of on-off control of the normally off type PMT by the gate signal, reception of the POS data by Ethernet and echo signal maximum value feedback are implemented, so that the present invention is suitable for all kinds of bathymetry LiDAR device; and the system is simpler in structure, and lighter and more portable while implementing high sampling rate and high-precision data sampling, the system occupies a small space, and has a weight of about 0.7 kg, a power consumption of 48 w to 50 w and a working temperature range of −10° C. to +40° C., and a synchronization error between channels is less than 300 ps, so that all kinds of scenes needing portable high sampling rate and high-precision data real-time acquisition and large-capacity storage can be met.

### BRIEF DESCRIPTION OF THE DRAWINGS

FIG. 1 is a block diagram of an FPGA internal design module of a lightweight and small single-band bathymetry LiDAR multi-channel high sampling rate and high-precision real-time synchronous acquisition and storage system.

FIG. 2 shows a workflow of the lightweight and small single-band bathymetry LiDAR multi-channel high sampling rate high sampling rate and high-precision real-time synchronous acquisition and storage system.

FIG. 3 shows an upper computer interface of the lightweight and small single-band bathymetry LiDAR multi-channel high sampling rate and high-precision real-time synchronous acquisition and storage system.

FIG. 4 shows table data of the lightweight and small single-band bathymetry LiDAR multi-channel high sampling rate and high-precision real-time synchronous acquisition and storage system.

FIG. 5 is an oscillogram of echo data acquired in an experiment of the lightweight and small single-band bathymetry LiDAR multi-channel high sampling rate and high-precision real-time synchronous acquisition and storage system.

### DESCRIPTION OF THE EMBODIMENTS

To make the objects, technical solutions and advantages of the present invention clearer, the preferred embodiments are given below, and specific embodiments of the present invention are further described in detail with reference to the drawings.

### EMBODIMENT

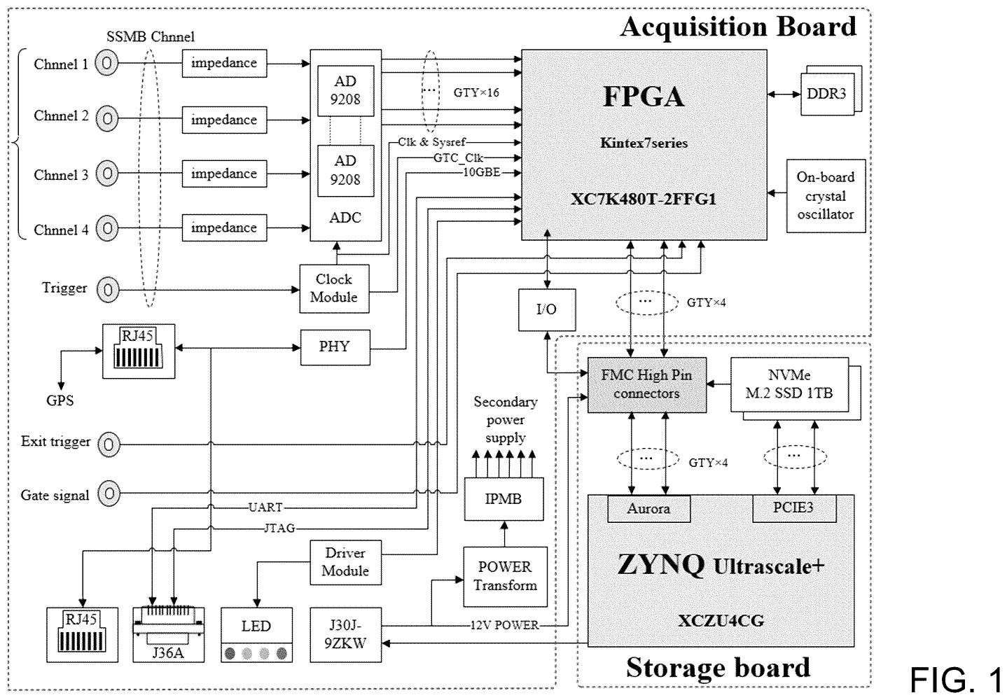

With reference to FIG. 1, a block diagram of an FPGA internal design module of a lightweight and small single-band bathymetry LiDAR multi-channel high sampling rate and high-precision real-time synchronous acquisition and storage system of the present invention is described. As shown in FIG. 1, the system adopts an ADC+FPGA+ZYNQ real-time acquisition and storage architecture, an FPGA chip is selected from a Xilinx Kintex7-Series chip and has a model of XC7K480tffg901-2, and an acquisition board is connected with a storage board through an FMC-HPC-400pins pin interface. A high sampling rate ADC data acquisition card is selected from an ADC chip AD9208 of ADI Company, the chip has a sampling rate of 2 GSPS (up to 3 GSPS in design) and a sampling precision of 14 bits, a system clock chip is selected from an HMC7043 chip of ADI Company, and a delay between four channels is less than 300 ps. The system designs eight SSMB-KW interfaces to the outside, four of which are input interfaces, three channels are selected in the art for receiving a laser device trigger signal and two PMT signals, and the other four interfaces are output interfaces for outputting the trigger signal to control light emission of a laser device and turning on and off of a normally off type PMT.

An AD9208 driver module, an HMC7043 clock driver module and an SPI protocol control module of the ADC chip are developed and designed with a VHDL logic language inside an FPGA, the three modules implement the acquisition and conversion of echo data through instantiated connection, and reduce a channel delay and improve an acquisition precision at the same time. A high sampling rate AD data control module designs start and end signals of AD data acquisition and storage, and acquisition delays and acquisition pulse widths of various channels, and the functions are all implemented by an FSM state machine. When the LiDAR starts to work, the laser device transmits the trigger signal to the high sampling rate acquisition system, and the system starts to work after receiving the trigger signal. Meanwhile, the module detects an amplitude threshold of a first channel, when an acquired numerical value of the channel reaches a set amplitude threshold, an enabling signal for data recording is pulled up in a current state, and data of a channel 2, a channel 3 and a channel 4 start to be recorded. Meanwhile, the enabling signal is kept for 2 clock periods in the next two states, until a high-level mark that signals of the four channels are all recorded is detected, the FSM returns to an initial state, and the system waits for the detection of the next start signal.

The system designs a gate signal control module with the VHDL language, the module is configured for controlling the turning on and off of the normally off type PMT, which implements adjustment of a gate signal pulse width in a range of 1 us to 10 us and adjustment of gate signal delay output time in a range of 1 ns to 500 ns, with error precisions of nanosecond. After the system starts to work, the module detects an internal frequency-doubled 500 MHz clock, and it is detected that a rising edge of the clock generates the trigger signal and two-stage registration is performed to ensure clock synchronization. Meanwhile, the FSM state machine enters a first state, and when the rising edge of the trigger signal of the system is detected at the moment, a counter inside the module starts to count and enters the next state. Whether a numerical value of the counter is equal to delay time set by a main control system is judged in a current state, wherein the time ranges from 1 ns to 500 ns, and when the numerical value counted by the counter is equal to the delay time, the gate signal pulls up the level, the state machine enters the next state at the same time, and the counter is cleared synchronously. Whether the numerical value of the counter is equal to pulse width time set by the main control system is judged in the current state, wherein the time ranges from 1 us to 10 us, and when the numerical value of the counter is equal to the pulse width time, the output of the gate signal is finished and the state machine enters an initial state to wait for the detection of the next trigger signal.

The system designs a channel echo data maximum value feedback module with the VHDL language, which is configured for feeding back an echo data maximum value to a main control board to implement adaptive adjustment of a PMT gain, and a data transmission module, which is configured for implementing data transmission (comprising A/D data, network data, serial data, and the like) inside the system. In the module, according to a main control clock of the bathymetry LiDAR system and a light emission frequency of the laser device, signal data of various channel are obtained once by the system at every 500 Hz, and the data maximum value is obtained by comparison in one laser pulse period and transmitted back to the main control system through a self-designed serial communication protocol at the same time to implement adaptive control of the PMT gain. In the module, a data maximum value acquisition and transmission module is designed, which implements the acquisition of four data at every 500 Hz in one laser pulse period and the output of a data maximum value comparison result, and generates maximum value acquisition modules of four channels at the same time; a data maximum value module is designed, which designs a numerical value comparator with the VHDL language to compare two numerical values and output the larger one for an upper module to call; and a data absolute value module is designed, which is configured for judging an acquired numerical value sign bit, when a numerical value is positive, the numerical value is directly output, and when the numerical value is negative, the data is forced to be converted into an integer type through a forced conversion module designed with the VHDL language, and then calculated and output in a form of data absolute value, and a larger numerical value is obtained by comparison through the data maximum value module.

The system designs an FMC high sampling rate interface with the VHDL language, and implements data interaction. The FMC interface module is configured for implementing high sampling rate data transmission and storage function control with the storage board, the module designs a communication protocol between the acquisition carrier board and the storage daughter board through the state machine, and implements the functions of data transmission to the storage daughter board and data reading from the storage daughter board and data uploading to the upper computer. In the state machine, according to a system transmission instruction, the carrier board sends the data to the storage board for storage. When the sent data is marked as “5”, it is indicated that the data storage is started, and all subsequent data need to be stored in the solid-state hard disk; when the acquired data sent from the carrier board is “9”, it is indicated that the storage board starts to receive the data; and when the sent data is “A”, it is indicated that the data storage is stopped. When a user needs to export data through the upper compute software, the acquisition carrier board receives a data instruction, and sends data with all data instructions being “E” to the storage board, and when the storage board detects the instruction, it is indicated that the data need to be exported to the acquisition carrier board. After receiving the instruction to export the data, the storage board waits for the user to select a corresponding file to be sent, and when an instruction with data of “7” is detected, the system starts to send the data, and the acquisition carrier board receives the data. When the data received by the acquisition carrier board are excessive, an instruction with data of “6” is sent to interrupt the transmission process, and the storage board stops current transmission after receiving the instruction. When the data received by the acquisition carrier board are no longer excessive, the system sends a data instruction with data of “9” to the storage board again, which indicates that the acquisition carrier board continues to receive the data. The above steps are repeated for many times until the data transmission is finished. After the data transmission is finished, the storage daughter board sends a data instruction with data of “8” to the system to indicate that the data export is ended, thus finishing GTX data transmission from the storage board to the acquisition carrier board.

The system designs a POS data transmission and storage module with the VHDL language. The POS data transmission module starts a POS network transmission function and records POS data by designing a UDP transmission protocol. When the system is powered on and starts to work, the system continuously sends data to the POS system through the UDP protocol designed with the VHDL, so as to start the network interface transmission function of the POS system and implement the storage of the POS data. Meanwhile, this function can also be implemented through serial communication, and the POS data are acquired by the main control system of the bathymetry LiDAR, transmitted to the high sampling rate acquisition system through J30J and stored. In a data serial transmission control module, the state machine is used to design and implement data capture permission and data capture completion marks. In an initial state, a level of the data capture permission mark is pulled up, and serial data are transmitted to an output interface of the module for a top module to use. Meanwhile, the next state is entered, whether the data capture completion mark is a high level is detected in the current state, and when the data capture completion mark is the high level, it is indicated that data capture and the transmission are finished, the data capture permission mark is pulled down, and the state returns to the initial state.

A storage part of the system is developed with the ZYNQ chip, and the module is connected with the acquisition carrier board through the FMC high sampling rate interface, which implements the real-time storage of the echo data and the POS data and the instruction interaction function with the carrier board of the system. Storage solid states are selected from two Samsung 970EVO Plus NVMe M.2 solid-state hard disks, and each solid state has a storage capacity of 1 TB and a storage bandwidth not less than 3.5 GB/s.

The system implements data transmission inside the system through a GTY Interface high sampling rate interface, designs an external serial port and a debugging interface inside the FPGA at the same time to facilitate debugging the FPGA when the function needs to be modified, and designs LED indicator lamps to the outside to indicate a running state of the LiDAR, a working state of the ADC chip and a working state of the FPGA chip. The stored data is connected to a computer and a high sampling rate acquisition system through a 100 Mbps Ethernet network cable, and the data export and file format conversion are implemented through the upper computer software.

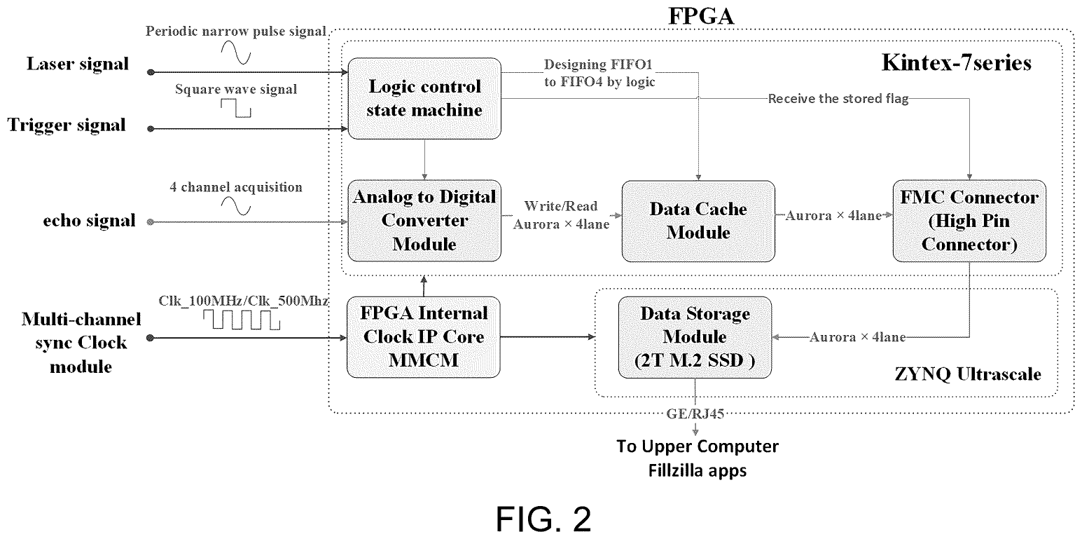

With reference to FIG. 2, how the working principle of the lightweight and small single-band bathymetry LiDAR multi-channel high sampling rate and high-precision real-time synchronous acquisition and storage system of the present invention is embodied in the workflow of the LiDAR is described in detail as follows: firstly, the present invention is connected with the bathymetry LiDAR, a power supply is uniformly supplied by a LiDAR power supply, and the power supply of the present invention is 12 V. A laser device trigger signal is connected to an SSMB-KW trigger input interface of the present invention; a laser device main wave signal, a normally on type PMT signal and a normally off type PMT signal are connected to four SSMB-KW input interfaces of the present invention; two of the four SSMB-KW output interfaces are respectively connected to an external trigger input interface of the laser device and a trigger interface of the normally off type PMT; a J30J interface of the present invention is connected to the system power supply and the main control system of the LiDAR; and POS system network interface data are connected to a 1,000 Mbps Ethernet interface of the present invention. Secondly, a switch of the system power supply of the LiDAR is turned on to wait for a main control touch screen of the system to show successful connection of the present invention, parameters such as a rotation speed of a scanning motor, acquisition pulse widths and acquisition delays of three acquisition channels, a pulse width and delayed output time of the gate signal of the normally off type PMT, and a working mode of the laser device are adjusted on the touch screen, he above parameters are all transmitted to the FGPA control chip by the main control system through the self-designed serial communication protocol, and the serial communication module designed by the FPGA control chip judges the working mode of the laser device and the parameters of various channels first according to the serial communication protocol, and changes acquired numerical values of the channels. In addition, when the setting of the parameters is finished, a running button on the touch screen is clicked, the LiDAR system starts to emit light and work, and the system starts to detect whether an amplitude of the laser device trigger signal of the first channel is greater than a preset amplitude threshold, when the amplitude is not greater than the threshold, the system considers the data to be invalid data, and the data is not recorded, only when the amplitude is greater than the preset threshold, the system starts to record data of four channels according to an acquisition pulse width and an acquisition delay adjusted on the main control screen, when the recording of the data is finished, data storage is started, and frame headers of various channels and whether various channels have the data to determine whether to record echo data of a current channel are detected in a storage process according to a self-designed format, when it is judged that the current channel has recorded data, a storage instruction is sent to the storage daughter board through the FMC interface, the FPGA chip starts to judge whether the next channel has recorded data at the same time, the storage board starts to store the data of the current channel after receiving the instruction, and sends a storage completion mark to the FPGA chip after finishing the storage while waiting for the FPGA chip to send the next storage instruction, until the storage of data of all channels is finished. A threshold of the next main wave is not judged before the storage of currently acquired data is finished in the whole process, and after the storage of all current data of the four channels is finished, a threshold of echo data of the first channel in the next set of data starts to be judged. The method not only ensures that the system does not record invalid and redundant data, but also ensures that the data of the four channels are completely recorded in the solid-state disk. Finally, after the work of the LiDAR is ended, the system and the PC terminal are connected through the 100 Mbps Ethernet interface, all data files stored in the solid-state disk are viewed through Filezilla software, and echo signal data are exported from the solid-state disk to the PC terminal through the 100 Mbps Ethernet. An exported file is opened through the upper computer conversion software and a storage location is selected to start to convert, and every 5000 pieces of data are stored as one csv file.

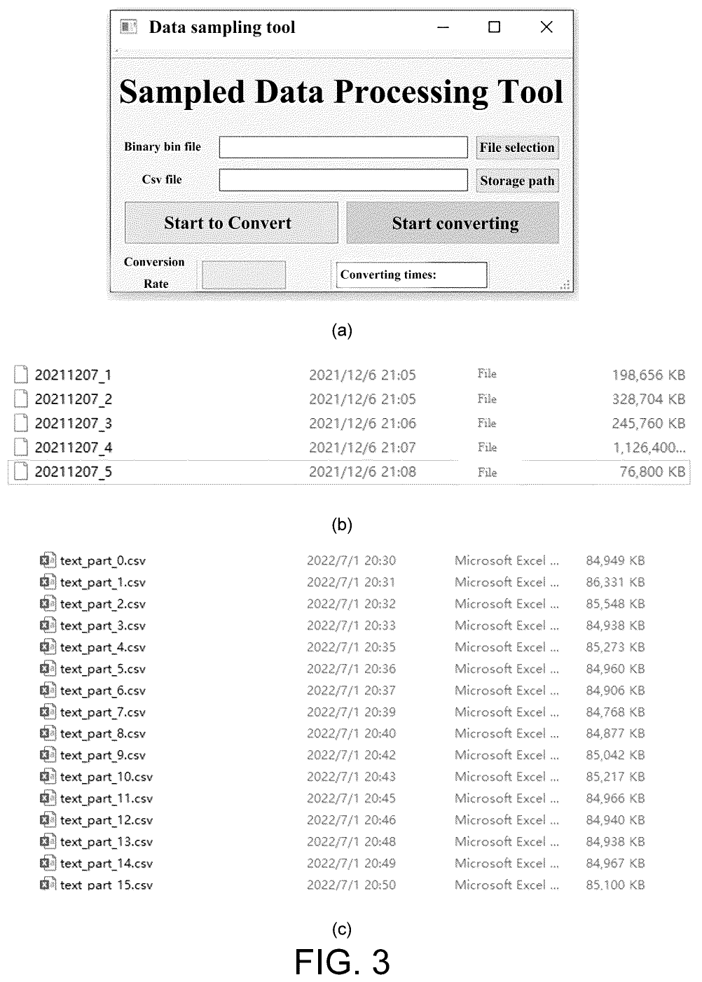

With reference FIG. 3, an upper computer main interface of the lightweight and small single-band bathymetry LiDAR multi-channel high sampling rate and high-precision real-time synchronous acquisition and storage system of the present invention is described. As shown in (a) of FIG. 3, the upper computer software is configured for converting a bin file into a decimal or hexadecimal csv file, and reading data of a file in self-designed format by a method of data type reading, and compared with a method of byte reading, a reading speed of the self-designed format is faster in the method, A binary bin file to be converted needs to be selected first in the software interface, as shown in (b) of FIG. 3, a storage path is selected at the same time, and a button of start to convert is clicked. Converted files are shown in (c) of FIG. 3, and each file contains 5000 pieces of waveform data.

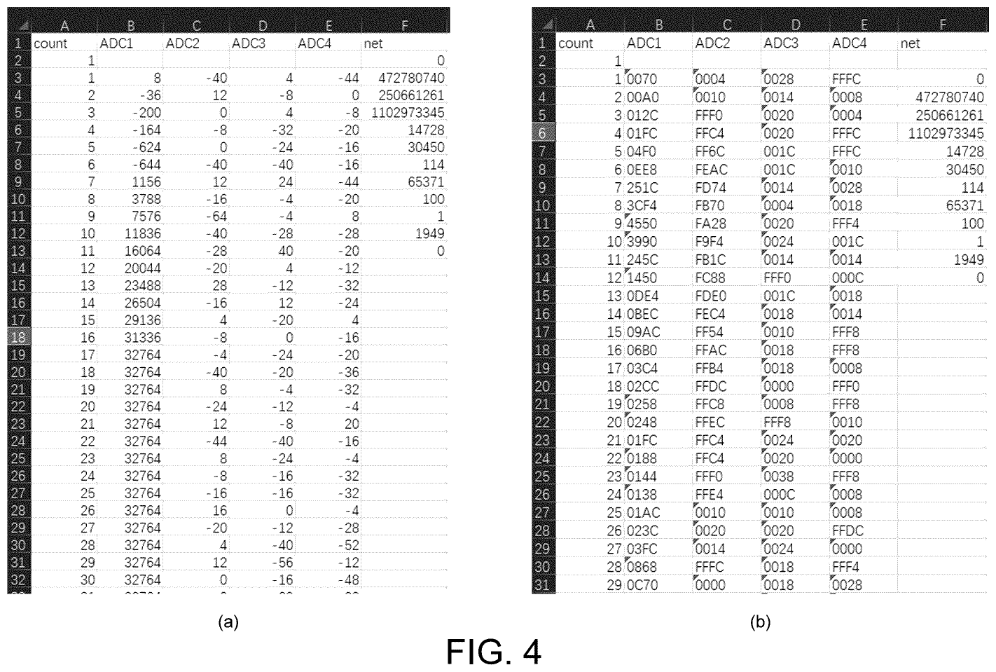

With reference to FIG. 4, csv table data of the lightweight and small single-band bathymetry LiDAR multi-channel high sampling rate and high-precision real-time synchronous acquisition and storage system of the present invention are described. (a) of FIG. 4 show a csv file in decimal format and (b) of FIG. 4 shows a csv file in hexadecimal format, with a function of completely recording data triggered each time according to the self-designed format. Column A records numbers of triggering times and time stamps of a current group, and because the sampling rate of the present invention is 2 GSPS, a unit of each grid in the file represents 0.5 ns. Columns B, C, D and E refer to four SSMB-KW input channels to the outside for receiving the echo data. Column E is configured for recording the POS data, which respectively records a number of triggering times of the laser device, a number of milliseconds, a latitude, a longitude and an elevation of a current position of the LiDAR, a heading angle, a pitching angle and a rolling angle of a movement platform equipped, and a rotation speed, a rotation angle and a number of scanning turns of the scanning motor. This csv file takes every 5000 pieces of echo data as one file.

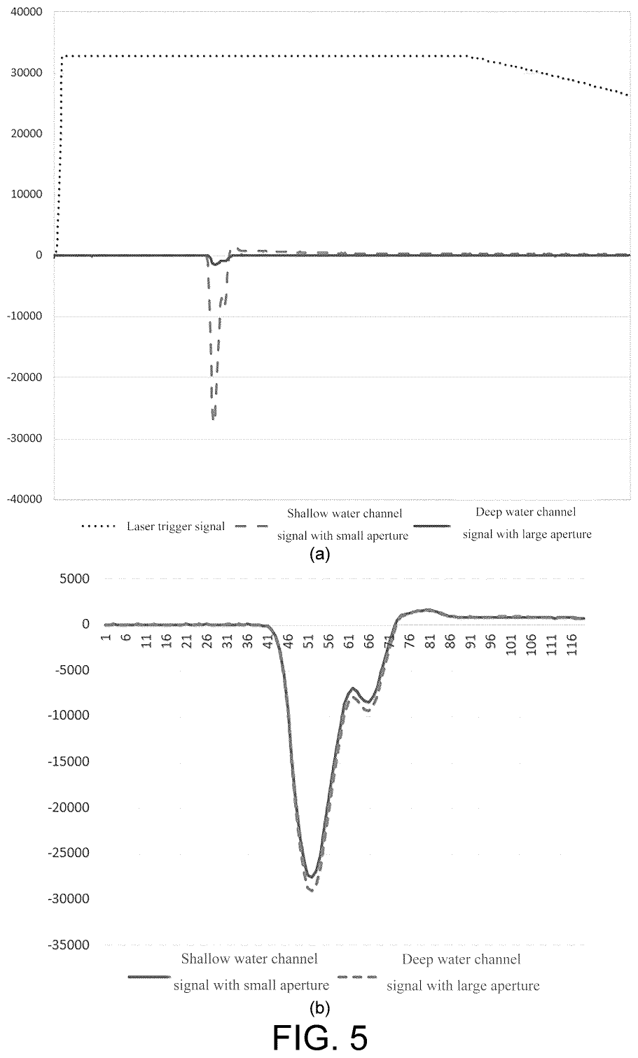

With reference to FIG. 5, an oscillogram of echo data of the lightweight and small single-band bathymetry LiDAR multi-channel high sampling rate and high-precision real-time synchronous acquisition and storage system of the present invention is described. As shown in FIG. 5, data of three channels triggered at one time are selected in the excel table to draw a line chart. (a) of FIG. 5 shows echo data of the three channels acquired by the art, wherein a point-like dotted line refers to a signal of the laser device, a strip-like dotted line refers to a small field shallow water channel signal, and a solid line refers to a large field deep water channel signal. (b) of FIG. 5 is a comparison diagram of small field shallow water channel echo data and large field deep water channel echo data of channels 2 and 3, wherein a solid line refers to the small field shallow water channel signal and a dotted line refers to the large field deep water channel signal. It can be seen from the comparison diagram that the acquired two signals are clearly distinguished into a water surface signal and a water bottom signal.

The above are merely basic solutions of specific embodiments of the present invention, but the scope of protection of the present invention is not limited to the basic solutions. Those skilled in the art may think of changes or substitutions within the technical scope disclosed by the present invention, and all the changes or substitutions should be included in the scope of protection of the present invention. Therefore, the scope of protection of the present invention should be subject to the scope of protection of the claims. All changes within the equivalent meanings and scope of the claims should be included within the scope of the claims.

What is claimed is:

1. A bathymetry LiDAR with multi-channel high sampling rate real-time synchronous acquisition and storage system, wherein the system is widely used in various bathymetry LiDARs, corresponding functional modules are designed for problems in bathymetry, and a system architecture is ADC+FPGA+ZNQ, and composed of an FPGA system acquisition carrier board, a ZYNQ storage daughter board and upper computer software; the system is powered by a 12 V power supply, and has a weight of about 0.7 kg, a power consumption of 48 w to 50 w and a working temperature range of −10° C. to +40° C., and a synchronization error between channels is less than 300 ps; the lightweight and small bathymetry LiDAR multi-channel high sampling rate real-time synchronous acquisition and storage system is composed of three parts comprising an FPGA acquisition carrier board unit, a ZYNQ storage daughter board unit and upper computer conversion software, each part is described in detail as follows: for the FPGA acquisition carrier board unit, an acquisition control chip is selected from a Kintex-7 series chip of Xilinx Company, named XC7K480tffg901-2, and is configured for implementing time sequence control of the lightweight and small bathymetry LiDAR multi-channel high sampling rate real-time synchronous acquisition and storage system and design of the functions with various modules; and the acquisition carrier board unit is integrated with five SSMB-KW input interfaces for acquiring an external analog signal, wherein a trigger input interface is configured for acquiring a laser device trigger signal, a first acquisition channel is configured for acquiring a laser device main wave signal, a second acquisition channel is configured for acquiring a small field shallow water channel signal from a normally on type PMT, and a third acquisition channel is configured for acquiring a large field deep water channel signal from a normally off type PMT; four SSMB-KW output interfaces for outputting a gate signal, controlling an external device, and implementing light emission of a laser device and on-off control of the normally off type PMT in the present invention, wherein a first output channel is configured for controlling the light emission of the laser device, and a second channel to a fourth channel all output the gate signal for controlling the PMT; two high sampling rate ADC chips selected from AD9208 chips of ADI Company, wherein the chip has a sampling rate of 2 GSPS (up to 3GSPS) and a sampling precision of 14 bits, the chip supports high sampling rate data serial output of a JESD204B protocol, meets a high sampling rate real-time acquisition requirement of the bathymetry LiDAR, and is configured for implementing data acquisition and analog-to-digital conversion of the external analog signal, and the driving of the module is implemented by FPGA design; one HMC7043 clock chip for providing a whole clock for the system, a high sampling rate ADC and a PLL, so as to implement data acquisition, which is namely system time allocation, and eliminate clock jitter at the same time, so that an error is reduced, a precision of output clock is greatly improved, and a guarantee is provided for high sampling rate real-time acquisition of a large amount of data of the bathymetry LiDAR; one 100 Mbps Ethernet interface configured for exporting data from a solid-state hard disk to a PC terminal in the present invention; one 1,000 Mbps Ethernet interface configured for triggering a transmission function of a POS system network interface in the present invention for POS data transmission; a UDP protocol designed by FPGA for continuously sending UDP data to a POS system while powering on the system; one J30J interface configured for system power supply and serial communication in the present invention; a self-designed communication protocol with contents comprising a working trigger mode of the laser device, data of a transmission code disk, peak data of AD of four channels and a parameter adjustment instruction of the gate signal; and one FMC interface configured for implementing internal data transmission, and storage instruction control and storage control of a storage board; to sum up, functions designed by the FPGA acquisition carrier board comprise high sampling rate A/D data acquisition, PMT gate signal output, POS network data transmission control, echo signal maximum value feedback, system data transmission, storage instruction control, serial instruction communication, and the like; for the ZYNQ storage daughter board unit, a daughter board chip is selected from a ZYNQ series chip of Xilinx, named ZYNQ Ultrascale+XCZU4CG, and is configured for receiving a storage instruction sent by the FPGA acquisition carrier board and implementing data storage, hard disks are selected from two Samsung 970EVO Plus NVMe M.2 solid states, a storage capacity of each solid state is TB, and the solid state supports an NVME protocol, has a faster storage speed, is configured for implementing real-time storage of echo data, and has a storage bandwidth not lower than 3.5 GB/s; the storage board is integrated with two NVME M.2 solid-state slots and one FMC high sampling rate interface; and for the upper computer conversion software, the software is capable of converting an original binary file in the solid-state hard disk into a plurality of csv files in decimal format or hexadecimal format, a file conversion format is self-designed, and design contents comprise a number of triggering times, a time stamp, ADC1, ADC2, ADC3, ADC4 and POS data, so that matching of the POS data with corresponding echo waveform data during later data processing is guaranteed, thus ensuring correctness of point cloud data; and the system provides four SSMB-KW input interfaces to the outside as echo signal input channels, which are configured for acquiring the laser device trigger signal, the small field shallow water channel signal from the normally on type PMT and the large field deep water channel signal from the normally off type PMT in the present invention; four SSMB-KW output interfaces, wherein four SSMB-KW output signals are configured for triggering turning on and off of the laser device and controlling turning on and off of the normally off type PMT, and configured for implementing external triggering of a working mode of the laser device and avoiding echo signal saturation; one trigger input configured for triggering the high sampling rate acquisition system to work; one network interface configured for receiving the POS data; one serial port configured for system power supply and instruction interactive communication with a main control system of the LiDAR (which is also used as a way to receive the POS data); one JTAG configured for implementing FPGA debugging; and one set of four LED lamps configured for indicating a running status of the system, a working status of the ADC chip and a working status of the FPGA chip.

2. The bathymetry LiDAR multi-channel high sampling rate real-time synchronous acquisition and storage system according to claim 1, wherein when the system is applied to the bathymetry LiDAR to work, a switch of a system power supply of the LiDAR is turned on to wait for a system main control touch screen to show successful connection of the present invention, parameters such as a rotation speed of a scanning motor, acquisition pulse widths and acquisition delays of three acquisition channels, a pulse width and delayed output time of the gate signal of the normally off type PMT, and a working mode of the laser device are adjusted on the touch screen, the above parameters are all transmitted to a FGPA control chip from the main control system through a self-designed serial communication protocol, the serial communication module designed by the FPGA control chip judges the working mode of the laser device and the parameters of various channels first according to the serial communication protocol, and changes acquired numerical values of channels; in addition, when the setting of the parameters is finished, a running button on the touch screen is clicked, the LiDAR system starts to emit light and work, and the system starts to detect whether an amplitude of the laser device trigger signal of the first channel is greater than a preset amplitude threshold, when the amplitude is not greater than the threshold, the system considers the data to be invalid data, and the data is not recorded, only when the amplitude is greater than the preset threshold, the system starts to record data of four channels according to an acquisition pulse width and an acquisition delay adjusted on the main control screen, when the recording of the data is finished, data storage is started, and frame headers of various channels and whether various channels have the data to determine whether to record echo data of a current channel are detected in a storage process according to a self-designed format, when it is judged that the current channel has recorded data, a storage instruction is sent to the storage daughter board through the FMC interface, the FPGA chip starts to judge whether the next channel has recorded data at the same time, the storage board starts to store the data of the current channel after receiving the instruction, and sends a storage completion mark to the FPGA chip after finishing the storage while waiting for the FPGA chip to send the next storage instruction, until the storage of data of all channels is finished; a threshold of the next main wave is not judged before the storage of currently acquired data is finished in the whole process, and after the storage of all current data of the four channels is finished, a threshold of echo data of the first channel in the next set of data starts to be judged; the method not only ensures that the system does not record invalid and redundant data, but also ensures that the data of the four channels are completely recorded in the solid-state disk; finally, after the work of the LiDAR is ended, the system and the PC terminal are connected through the 100 Mbps Ethernet interface, all data files stored in the solid-state disk are viewed through Filezilla software, and echo signal data are exported from the solid-state disk to the PC terminal through the 100 Mbps Ethernet; and an exported file is opened through the upper computer conversion software and a storage location is selected to start to convert, and every 5000 pieces of data are stored as one csv file.

3. The bathymetry LiDAR multi-channel high sampling rate real-time synchronous acquisition and storage system according to claim 1, wherein the upper computer software reads data of a file in self-designed format by a method of data type reading, compared with a method of byte reading, a reading speed of the self-designed format is faster in the method, the software is capable of implementing conversion of an original binary bin file of echo data in self-designed format acquired into a decimal or hexadecimal data csv file at the same time, contents of the self-designed csv file comprise a number of triggering times and a time stamp of current echo data, echo data of four channels and POS data (a number of triggering times of the laser device, a number of milliseconds, a current position latitude, a current position longitude, a current position elevation, a device heading angle, a device pitching angle, a device rolling angle, a motor rotation speed, a motor rotation angle, a number of turns of motor, and other parameters), each csv file contains 5000 pieces of waveform data, and one original bin file is capable of being converted into multiple sets of csv file.
